(19) United States
(12) Patent Application Publication
(10) Pub. No.: US 2009/0325428 A1
(43) Pub. Date: Dec. 31, 2009

(54) FLEXIBLE TO RIGID CABLE BARREL SPLICE

(75) Inventor: Kharyl STEPHENS, Greenville, SC (US)

Correspondence Address: McNees Wallace & Nurick, LLC, 100 Pine Street, P.O. Box 1166, Harrisburg, PA, 17108-1166, US

(73) Assignee: GENERAL ELECTRIC COMPANY, Schenectady, NY (US)

(21) Appl. No.: 12/199,974

(22) Filed: Aug. 28, 2008

Related U.S. Application Data
(60) Provisional application No. 61/076,904, filed on Jun. 30, 2008.

(51) Int. Cl. H01R 4/10; H01R 43/04

(52) U.S. Cl. 439/879; 29/753

(57) ABSTRACT

A method of connecting conductors including inserting a first conductor into a first end of a compression sleeve, inserting a second conductor into a second end of a compression sleeve, and crimping the compression sleeve, a compression sleeve including a first conductor-receiving pocket proximal to a first end of the compression sleeve configured to receive a first conductor and a second conductor-receiving pocket proximal to a second end of the compression sleeve configured to receive a second conductor, and a process of making a compression sleeve is disclosed.

### CROSS REFERENCE TO RELATED PATENT APPLICATIONS

This application claims the benefit of U.S. Provisional Application No. 61/076,904, filed Jun. 30, 2008, which Application is hereby incorporated by reference in its entirety.

### FIELD

The present disclosure is directed to a compression sleeve. In particular, the present disclosure is directed to a compression sleeve for splicing conductors with differing torsional compliance.

### BACKGROUND

Compression sleeves or splices have been used in electrical distribution networks for joining conductors. Splice connections have been improved to permit splicing electrical conductors of dissimilar diameters, dissimilar cross-sections, and dissimilar geometries. To permit these splices, sleeve-conductor-reducing adapter assemblies have been used. Other forms of electrical connectors, such as bus bars and junction boxes, have been used for creating these electrical connections.

These electrical connecting methods and electrical connectors do not permit the splicing of conductors of dissimilar materials or structures. The inability to permit the splicing of such conductors prevents substitution of rigid cable for highly flexible cable unless junction boxes with bus bars are used or paddle lugs are bolted together. This inability is due to failure of electrical connectors when force is exerted axial to the connector (pull out force). Alternatively, this inability is also due to failure of electrical connectors to maintain a specified regulated temperature when subjected to static heating and/or cycling currents. Standards, such as Underwriter Laboratories Standard 486 (UL 486) and International Electrotechnical Commission 61238 (IEC 61238) identify minimal pull out force resistance and/or maximum temperature rise ratings when subjected to static heating and/or cycling currents. For copper and/or aluminum wire sizes 30 AWG to 2000 kcmil, pull out resistance values per UL 486 vary from 1.5 to 2000 lbs. for 1 minute. Also per UL 486, the maximum temperature rise for static heating currents shall not exceed 50° C. or 125° C. for cycling current.

Recently, wind turbines have received increased attention as an environmentally safe and relatively inexpensive alternative energy source. With this growing interest, considerable efforts have been made to develop wind turbines that are reliable and efficient.

Generally, a wind turbine includes a plurality of blades coupled to a rotor through a hub. The rotor is mounted within a housing or nacelle, which is positioned on top of a tubular tower or base. Blades on these rotors transform wind energy into a rotational torque or force that drives the rotor, which is rotationally coupled to a generator. The rotor is supported by the tower through a bearing that includes a fixed portion coupled to a rotatable portion. The bearing is subject to a plurality of loads including the weight of the rotor, a moment load of the rotor that is cantilevered from the bearing, asymmetric loads, such as, horizontal and shears, yaw misalignment, and natural turbulence.

In the wind turbine industry, highly flexible cable with notable torsional compliance is required to accommodate the rotation of the nacelle around the tower. Torsional compliance is the reciprocal of torsional rigidity; torsional rigidity is defined to include the ratio of torque applied about a centroidal axis of a bar at one end of the bar to a resulting torsional angle, when the other end is held fixed. The inability to substitute rigid cable with less torsional compliance for highly flexible cable without requiring junction boxes with bus bars or paddle lugs bolted together results in increased material cost of products, increased installation time, increased maintenance requirements, increased complexity of installation, and/or long portions of highly flexible cable of a wind turbine system and/or the expense and use of junction boxes or bolted paddle lugs.

### SUMMARY

This disclosure provides a method of connecting a compression sleeve, a compression sleeve, and a process of making a compression sleeve permitting substitution of rigid cable for highly flexible cable.

According to an embodiment, a method of connecting conductors includes the steps of inserting a first conductor into a first end of a compression sleeve, inserting a second conductor into a second end of a compression sleeve, and crimping the compression sleeve. In the embodiment, the first conductor has more torsional compliance than the second conductor.

According to another embodiment, a compression sleeve includes a first conductor-receiving pocket proximal to a first end of the compression sleeve configured to receive a first conductor and a second conductor-receiving pocket proximal to a second end of the compression sleeve configured to receive a second conductor. In the embodiment, the compression sleeve is configured to be crimped. The first conductor-receiving pocket includes a first central bore, the second conductor-receiving pocket includes a second central bore, and the first conductor and the second conductor differ in torsional compliance.

According to yet another embodiment, a process of making a compression sleeve includes the steps of providing a tubular body with a first end and a second end defined by an outer perimeter that is generally tubular with a first conductor-receiving pocket proximal to the first end and a second conductor-receiving pocket proximal to the second end, inserting a first conductor having a first cross-sectional area into the first conductor-receiving pocket, inserting a second conductor having a second cross-sectional area into the second conductor-receiving pocket, crimping the compression sleeve, providing a force to pull out the first conductor, the second conductor, or the first conductor and the second conductor, measuring the pull out resistance of the compression sleeve, exceeding the failure point for pull out resistance of the compression sleeve, identify a failing conductor, and configuring the compression sleeve to increase the failure point for pull out resistance. In the embodiment, the first conductor-receiving pocket is partially defined by a first bore and the second conductor-receiving pocket is partially defined by a second bore. The first bore has a first inner diameter and the second bore has a second inner diameter. The compression sleeve is crimped to secure the conductors in the bores. The first conductor and the second conductor differ in torsional compliance. The failing conductor is determined based upon whether the first conductor or the second conductor fails.

An advantage of the present disclosure is the ability to substitute rigid cable for highly flexible cable without requiring junction boxes with bus bars or bolting paddle lugs together.

Another advantage of the present disclosure is decreased material cost of products.

Yet another advantage of the present disclosure is decreased installation time.

Still yet another advantage is decreased complexity of installation.

A further advantage is not requiring as much highly flexible cable for wind turbines.

Another further advantage is exceeding predetermined pull out requirements.

Yet another further advantage is improved impedance due to the removal of a junction box and paddle lugs.

Still yet another further advantage is reduced repair requirements.

A different advantage is easier ability for repairs.

Another different advantage is reduced down time.

Further aspects of the method and system are disclosed herein. The features as discussed above, as well as other features and advantages of the present disclosure will be appreciated and understood by those skilled in the art from the following detailed description and drawings.

### BRIEF DESCRIPTION OF THE DRAWINGS

FIG. 1 illustrates a side elevation view of an exemplary embodiment of a compression sleeve according to the disclosure.

FIG. 2 illustrates a side view of an exemplary embodiment of compression sleeves according to the disclosure showing the compression sleeves in series.

FIG. 3 illustrates a side elevation view of another exemplary embodiment of a compression sleeve according to the disclosure.

FIG. 4 illustrates a side elevation view of yet another exemplary embodiment of a compression sleeve according to the disclosure.

FIG. 5 illustrates a side elevation view of still yet another exemplary embodiment of a compression sleeve according to the disclosure.

FIG. 6 illustrates a side elevation view of an additional exemplary embodiment of a compression sleeve according to the disclosure.

FIG. 7 illustrates a side elevation view of another additional exemplary embodiment of a compression sleeve according to the disclosure.

Wherever possible, the same reference numbers will be used throughout the drawings to represent the same parts.

### DETAILED DESCRIPTION

The present disclosure now will be described more fully hereinafter with reference to the accompanying drawings, in which a preferred embodiment of the disclosure is shown. This disclosure may, however, be embodied in many different forms and should not be construed as limited to the embodiments set forth herein; rather, these embodiments are provided so that this disclosure will be thorough and complete and will fully convey the scope of the disclosure to those skilled in the art.

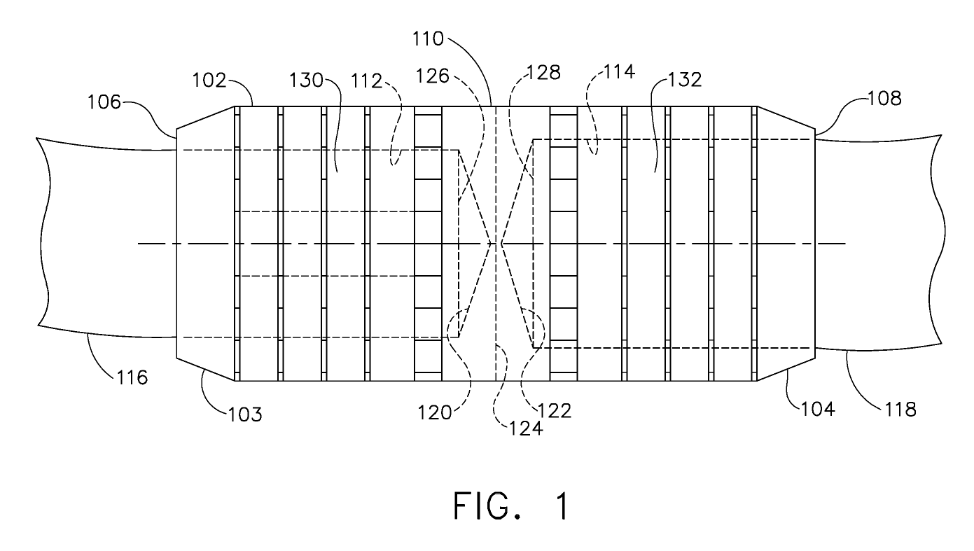

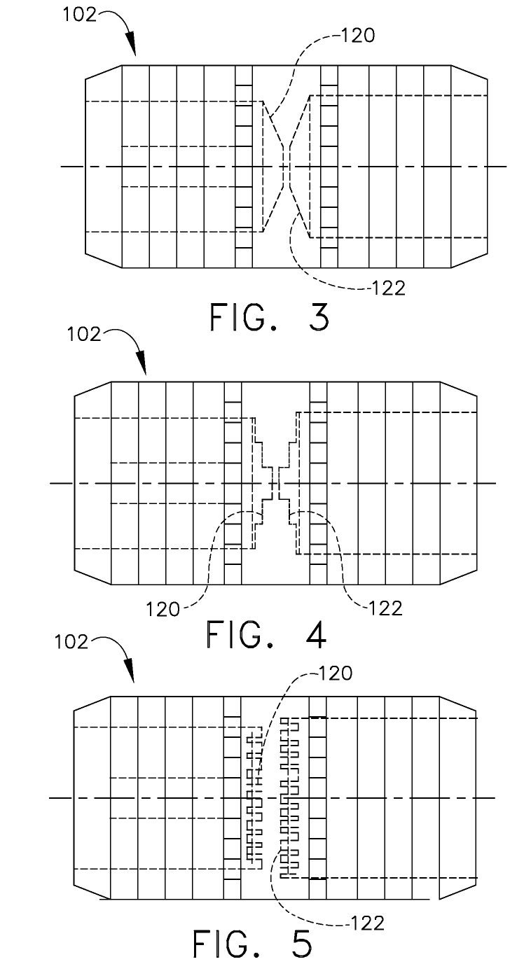

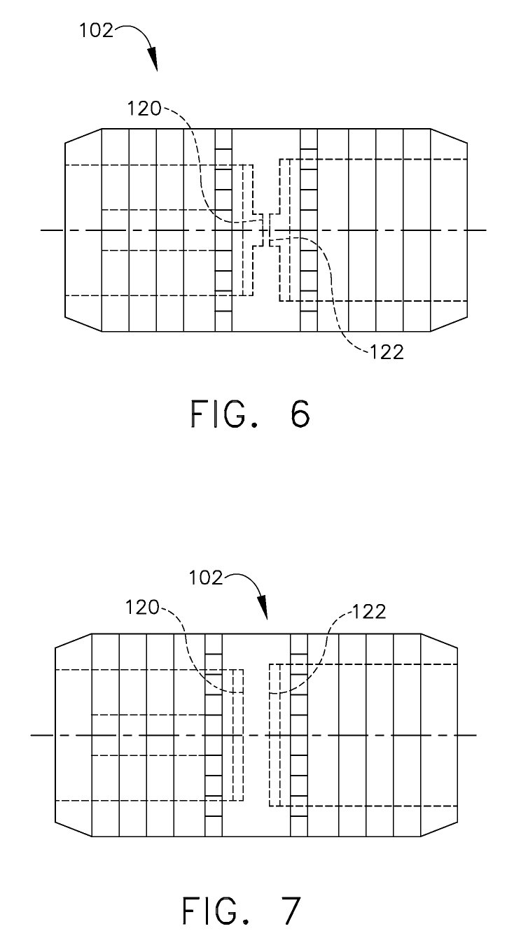

FIG. 1 illustrates an embodiment of a compression sleeve 102 according to the disclosure (the term compression sleeve includes the term compression splice and barrel splice). In this embodiment, the compression sleeve 102 is a tubular body with a first end 106 and a second end 108. As shown, the first end 106 may include a tapered portion 103 and the second end 108 may also include a tapered portion 104. Compression sleeve 102 is defined by an outer perimeter 110 that is generally tubular. Compression sleeve 102 includes a first conductor-receiving pocket 130 proximal to first end 106 and a second conductor-receiving pocket 132 proximal to second end 108. First conductor-receiving pocket 130 is partially defined by a first central bore 112 configured to permit insertion of a first conductor 116, which has a first cross-sectional area (not shown), into first end 106 and is partially defined by a first portion 120, which is configured to abut first conductor 116 upon first conductor 116 being fully inserted into first conductor-receiving pocket 130. Second conductor-receiving pocket 132 is partially defined by a second central bore 114 configured to permit insertion of a second conductor 118, which has a second cross-sectional area (not shown), into second end 108 and is partially defined by a second conical portion 122, which is configured to abut second conductor 118 upon second conductor 118 being fully inserted into second conductor-receiving pocket 132. First conductor-receiving pocket 130 and second conductor-receiving pocket 132 converge at a center 124 of compression sleeve 102. In the embodiment illustrated in FIG. 1, first portion 120 and second portion 122 are conical in geometry; however, as illustrated in FIGS. 3 through 7, first portion 120 and/or second portion 122 may have any other geometry including, but not limited to, frusto-conical (see e.g., FIG. 3), stepped (see e.g., FIG. 4), with a plurality of holes (see e.g., FIG. 5), with one hole (see e.g., FIG. 6), flat (see e.g., FIG. 7), and any other geometric configurations. In addition, the geometry of first portion 120 and second portion 122 may differ.

In the embodiment illustrated in FIG. 1, first conductor-receiving pocket 130 includes a first bore-diameter 126 and second conductor-receiving pocket 132 includes a second bore-diameter 128. First bore-diameter 126 and second bore-diameter 128 may differ. Conductor-receiving pockets 130, 132 are of a size, geometry, and length to correspond with the corresponding conductor. In the other embodiments, conductor-receiving pockets 130, 132 may be modified to accommodate differing sized conductors 116, 118 by including adapters as disclosed in U.S. Pat. No. 6,310,292, filed Jan. 20, 1995 (“Osborn”), which is herein incorporated by reference in its entirety. In yet other embodiments, conductor-receiving pockets 130, 132 may be modified to accommodate differing geometry or length conductors. In addition, in further embodiments, adapters may be comprised of materials or structures differing from conductors 116, 118.

Referring again to FIG. 1, in the illustrated embodiment, compression sleeve 102 is comprised generally of a ductile, deformable material that does not readily corrode, does not stress relax, and can withstand conditions of use in wind turbines. For instance, in the embodiment illustrated in FIG. 1, compression sleeve 102 includes the material aluminum with a tin plated finish. The material of compression sleeve 102 is not so limited and may be comprised of any ductile, deformable material. In the illustrated embodiment, first central bore 112 and second central bore 114 treated with a joint compound as is well known in the art. For example, Penetrox™ A13 (a synthetic base vehicle in which zinc particles are suspended) may be used for treating first central bore 112 and second central bore 114 to prevent oxidation. Using such a synthetic based vehicle is particularly used with aluminum conductors. As will be understood by those skilled in the art, in other embodiments, compression sleeve 102 may be comprised of other materials and may be treated by other means.

In the embodiment illustrated by FIG. 1, compression sleeve 102 is configured to connect conductors 116, 118 by permitting conductors 116, 118 to be inserted into ends 106, 108 of compression sleeve 102. Upon being inserted into ends 106, 108 of compression sleeve 102, conductors 116, 118 slidably engage central bores 112, 114 of compression sleeve 102 by being slid toward center 124 of compression sleeve 102 thereby permitting portions 120, 122 of compression sleeve 102 to abut conductors 116, 118. Upon being fully inserted, conductors 116, 118 substantially fill conductor-receiving pockets 130, 132.

For improved electrical performance, in another embodiment, conductors 116, 118 may be scratch brushed prior to insertion into compression sleeve 102. Scratch brushing is a process of abrading the surface of a conductive material and is well known by those skilled in the art. Such a procedure is particularly used with aluminum conductors.

In the embodiment illustrated in FIG. 1, upon conductors 116, 118 being properly positioned into compression sleeve 102, compression sleeve 102 is crimped by deforming outer perimeter 110 and collapsing the conductor-receiving pocket to create an interference fit for the conductor. In one embodiment, the crimping is performed by using a crimping tool. In the embodiment, the crimping tool may be dieless or require a set of dies. The crimping tool may be capable of performing one or multiple crimps at any one time. The crimping of one compression sleeve 102, as opposed to using a junction box with a bus or crimping two separate paddle lugs and bolting them together, should decrease impedance. In addition, the crimping of compression sleeve 102 should prevent conductors 116, 118 from being pulled out of compression sleeve 102.

The aforementioned features of compression sleeve 102 provide additional means for preventing conductors 116, 118 from being pulled out of compression sleeve 102 because conductors 116, 118 differ in torsional compliance. The illustrated embodiment of compression sleeve 102 should meet pull out requirements under Underwriter Laboratories Standard 486 (UL 486) and/or International Electrotechnical Commission 61238 (IEC 61238). In the illustrated embodiment, the pull out requirements may exceed UL 486 by a factor of eight to nine. If the compression sleeve is not able to withstand the pull out force or the crimp load, then over-flash (which results in the conductor material bleeding out along an axis of compression sleeve 102 or producing a bulge or sharp edge in compression sleeve 102) and/or broken strands would result.

Referring again to FIG. 1, compression sleeve 102 is configured to prevent over-flash and broken strands by modifying the diameter of bores 112, 114, by modifying the profile of compression sleeve 102, and/or by modifying the crimping tool and/or die set. These modifications are made based upon the results of tests designed to comply with UL 486 or IEC 61238. Although the larger diameter bore usually corresponds with conductors 116, 118 with less torsional compliance, testing of the conductors of specific materials and/or structures is required to assure compliance with UL 486 or other standards. Generally, the process of making compression sleeve 102 includes inserting first conductor 116 into first conductor-receiving pocket 130, inserting second conductor 118 into second conductor-receiving pocket 132, crimping compression sleeve 102, measuring the pull out resistance of compression sleeve 102, exceeding the failure point for pull out resistance of compression sleeve 102, identify a failing conductor, and producing a reengineered sleeve to increase the failure point for pull out resistance, wherein the failing conductor is determined based upon whether the force on the first conductor or the second conductor results in over-flash or broken strands. Reengineered sleeve is substantially the same as compressor sleeve 102 but for having modifications based upon the failure of the conductor.

When compression sleeve 102 is tested, if conductor 116 fails due to over-flash and/or broken strands, in one embodiment, bore-diameter 126 of reengineered sleeve (not shown) will be larger but bore-diameter 128 will remain unchanged. When compression sleeve 102 is tested, if conductor 118 fails due to over-flash or broken strands, in one embodiment, bore-diameter 128 of a reengineered sleeve (not shown) will be larger but bore-diameter 126 will remain unchanged. Reengineered sleeve is then tested to determine compliance with UL 486 or other predetermined force and/or thermal requirements. This process is repeated until reengineered sleeve exceeds the UL 486 standard or other predetermined force and/or thermal requirements. Upon determining the appropriate design for reengineered sleeve to comply with UL 486 and/or IEC 62238, the design is used for fabricating additional compression sleeves 102.

When compression sleeve 102 is tested, if conductor 116 fails due to over-flash or broken strands, in another embodiment, outer perimeter 110 of a reengineered sleeve (not shown) will be larger on the portion surrounding conductor 118 but remain the same on the portion surrounding conductor 116. When compression sleeve 102 is tested, if conductor 118 fails due to over-flash or broken strands, in another embodiment, outer perimeter 110 of a reengineered sleeve (not shown) will be larger on the portion surrounding conductor 116 but remain the same on the portion surrounding conductor 118. The reengineered sleeve is then tested to determine compliance with UL 486 or other predetermined force and/or requirements. This process is repeated until reengineered sleeve exceeds the UL 486 standard or other predetermined force and/or requirements. Upon determining the appropriate design for reengineered sleeve to comply with UL 486 and/or IEC 61238, the design is used for fabricated additional compression sleeves 102.

When compression sleeve 102 is tested, if conductor 116 fails due to over-flash or broken strands, in another embodiment, the crimping tool (or a corresponding die set within the crimping tool) corresponding with compression sleeve 102 is modified to redistribute the force and/or increase/decrease the amount of force on the portion of compression sleeve 102 surrounding second conductor 118. When compression sleeve 102 is tested, if conductor 118 fails due to over-flash or broken strands, in another embodiment, the crimping tool (or a corresponding die within the crimping tool) corresponding with compression sleeve 102 is modified to redistribute the force and/or increase/decrease the amount of force on the portion of compression sleeve 102 bounding second conductor 118. A new compression sleeve 102 is then tested to determine compliance with UL 486 or other predetermined force and/or thermal requirements. This process is repeated until compression sleeve 102 exceeds the UL 486 standard or other predetermined force and/or thermal requirements. Upon determining the appropriate design for compression sleeve 102 to comply with UL 486 and/or IEC 61238, the design is used for fabricated additional compression sleeves 102.

Referring again to FIG. 1, conductors 116, 118 of compression sleeve 102 differ in the level of torsional compliance. In the illustrated embodiment, first conductor 116 has more torsional compliance than second conductor 118. For multifilamental structures used as conductors 116, 118, the term torsional compliance also includes the relative movement among filaments of the structure. The torsional compliance of conductors 116, 118 differs based upon using different materials or using different compactness (explained below) of the structures of conductors 116, 118.

Regarding the different material, first conductor 116 material and second conductor 118 material are conductive materials. The level of torsional compliance should differ, at least slightly, between any differing materials. The conductive materials must be strong enough to resist the pull out tests associated with UL 486 and/or IEC 61238, must effectively conduct electricity, and must meet torsional compliance needs of the specific application. The conductive materials used for first conductor 116 include, but are not limited to, copper, copper alloys (including brass or bronze), aluminum, copper-clad aluminum, aluminum alloys, magnesium, molybdenum, nickel, silver, titanium, iron, steel, conductive polymers, and any other conductive material. The conductive materials for second conductor 118 may be a different conductive material from the conductive material used for the first conductor 116 but selected from the same group of conductive materials used for first conductor 116. In one embodiment, first conductor 116 material is copper thereby requiring second conductor 118 to be comprised of a conductive material other than copper (for instance, aluminum). Using different materials for first conductor 116 and second conductor 118 results in differing properties for conductors 116, 118. One such differing property is the torsional compliance. In the illustrated embodiment, first conductor 116 (being comprised of copper) and second conductor 118 (being comprised of aluminum) will bend, flex, twist, deform, and return to their original form at differing degrees. In the illustrated embodiment, the structure of the material for first conductor 116 and second conductor 118 are the same.

The term compactness refers to the structure of the conductive material in the conductor. The level of torsional compliance should differ, at least slightly, between any conductive material with a differing structure. The structure of conductors 116, 118 includes the physical characteristics of conductors 116, 118. The structure may be generally multifilamental, may be compact stranded, may be compressed stranded, may be solid, may be homogenous, and/or may differ based upon other physical characteristics. Generally, multifilamental structures include lattices, strands, or fibrous portions. Compact stranded structures include outer edges substantially rounded but compressed so tightly that substantially no air gaps exist. Compressed stranded structures include outer edges that are not as round as those in compact stranded structures and may have little bumps. Solid structures are defined to include structures such as pipes, bars, and solid wire. In the embodiment illustrated in FIG. 1, first conductor 116 is a multifilamental structure with flexible rope-lay stranded characteristics and second conductor 118 is a compact stranded structure. In the illustrated embodiment, the differing structure results in differing levels of compactness thereby resulting in differing level of torsional compliance between first conductor 116 and second conductor 118. In another embodiment, the material of first conductor 116 and second conductor 118 differ and the structure of first conductor 116 and second conductor 118 differ thereby resulting in differing levels of torsional compliance.

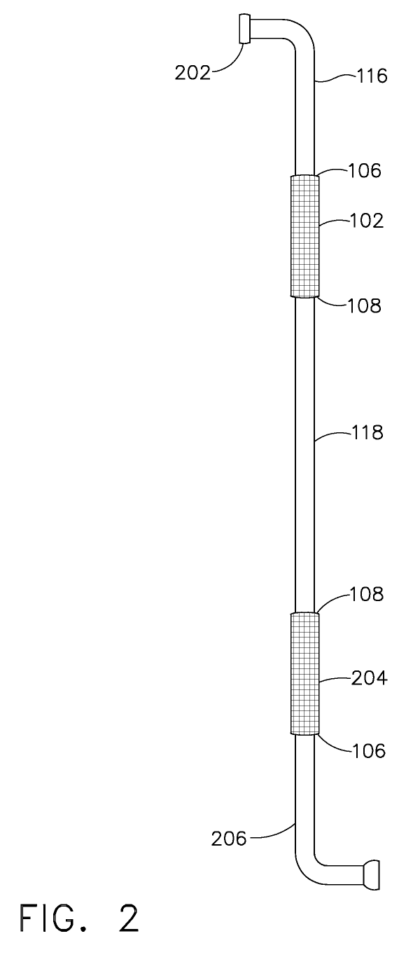

Referring to FIG. 2, in the illustrated embodiment, compression sleeve 102 is used for substituting first conductor 116 of one material or structure for second conductor 118 of another material or structure. Among other benefits, this substitution permits less expensive conductors to be used in situations where torsional compliance is not a necessary property. As illustrated in FIG. 2, first conductor 116 is connected to a paddle lug 202, which may be attached to a turbine, generator, or other device configured to be in electrical communication with a conductor, on one end of first conductor 116 and the other end of first conductor 116 is positioned inside compression sleeve 102 in first conductor-receiving pocket 130 (shown in FIG. 1) proximal to first end 106 of compression sleeve 102. As shown, second conductor 118 is positioned inside second conductor-receiving pocket 132 (shown in FIG. 1) proximal to second end 108 of compression sleeve 102. In the illustrated embodiment, second conductor 118 is positioned inside second conductor-receiving pocket 132 (shown in FIG. 1) of an additional compression sleeve 204. An additional first conductor 206 (a conductor of the same material and/or structure as the first conductor 116) is positioned inside an additional compression sleeve 204 in first conductor-receiving pocket 130 (shown in FIG. 1) proximal to first end 106 of additional compression sleeve 204. In another embodiment, the additional first conductor 206 is comprised of a material and/or structure differing the second conductor 118 and possibly the first conductor 116.

The use of additional compression sleeve 204 in series with compression sleeve 102 is necessary to allow substitution of conductors when torsional compliance of conductors 116, 206 is required for the specific application. Such a need exists in the wind turbine industry, where first conductor 116 is attached to paddle lug 202 proximal to the nacelle requiring torsional compliance to withstand the rotation of the blades around the tower and to withstand corresponding yaw. In such configurations, first conductor 116 is also attached to the bottom portion and/or outside of the wind turbine requiring flexibility to properly fit within existing power cabinets and/or to connect to other power equipment such as a transformer. In another embodiment, where only one portion of the configuration requires torsional compliance, only one compression sleeve 102 is used and the conductor with less torsional compliance replaces the remaining portions. In yet another embodiment, multiple additional compression sleeves 204 are used for accommodating configurations requiring torsional compliance at more than two portions. In a further embodiment, compression sleeves 102 and the additional compression sleeves 204 are used in applications permitting the use of other conductor materials with properties more suitable to the portion of the configuration proximal to those portions of the conductors. For instance, in these further embodiments, conductors with more corrosion resistance may be used in portions of a configuration exposed to moisture. In yet a further embodiment, the configuration may be inserted inside of a pipe.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A method of connecting conductors comprising the steps of:
inserting a first conductor into a first end of a compression sleeve;
inserting a second conductor into a second end of a compression sleeve;
crimping the first end of the compression sleeve;
crimping the second end of the compression sleeve;
wherein the first conductor has more torsional compliance than the second conductor.

2. The method of claim 1, further comprising inserting at least one adapter into the first end or the second end of the compression sleeve.

3. The method of claim 1, further comprising connecting the first conductor, the second conductor, or the first conductor and the second conductor to an additional compression sleeve.

4. The method of claim 1, further comprising connecting the first conductor or the second conductor to a wind turbine.

5. The method of claim 1, further comprising exceeding at least one of UL 486 and IEC 61238.

6. A compression sleeve comprising:
a first conductor-receiving pocket proximal to a first end of the compression sleeve configured to receive a first conductor; and
a second conductor-receiving pocket proximal to a second end of the compression sleeve configured to receive a second conductor;
wherein the compression sleeve is configured to be crimped;
wherein the first conductor-receiving pocket comprises a first central bore;
wherein the second conductor-receiving pocket comprises a second central bore; and
wherein the first conductor and the second conductor differ in torsional compliance.

7. The compression sleeve of claim 6, further comprising a conical portion, wherein the conical portion partially defines the first conductor-receiving pocket.

8. The compression sleeve of claim 6, further comprising a first bore-diameter and a second bore-diameter, wherein the first bore-diameter and the second bore-diameter differ.

9. The compression sleeve of claim 6, further comprising an adapter.

10. The compression sleeve of claim 6, wherein the compression sleeve is configured to prevent the first conductor and the second conductor from being pulled out with a force below a force required under or IEC 61238.

11. The compression sleeve of claim 6, wherein the compression sleeve is configured to prevent the first conductor and the second conductor from being pulled out with a force below a force required under UL 486.

12. The compression sleeve of claim 6, wherein the compression sleeve is configured to substantially prevents over-flash or broken stands.

13. The compression sleeve of claim 6, further comprising the first conductor and the second conductor; wherein the first conductor or the second conductor is connected to a wind turbine.

14. The compression sleeve of claim 6, further comprising the first conductor and the second conductor; wherein the first conductor or the second conductor is connected to an additional compression sleeve.

15. The compression sleeve of claim 6, wherein the first conductor is comprised of a conductive material differing from the second conductor.

16. The compression sleeve of claim 6, wherein the first conductor has a differing structure than the second conductor.

17. The process of making a compression sleeve comprising the steps of:
providing a tubular body with a first end and a second end defined by an outer perimeter that is generally tubular with a first conductor-receiving pocket proximal to the first end and a second conductor-receiving pocket proximal to the second end; wherein the first conductor-receiving pocket is partially defined by a first bore and the second conductor-receiving pocket is partially defined by a second bore; wherein the first bore has a first cross-sectional area and the second bore has a second cross-sectional area; wherein the compression sleeve is configured to be crimped;
inserting a first conductor having a cross-sectional area into the first conductor-receiving pocket,
inserting a second conductor having a second cross-sectional area into the second conductor-receiving pocket,
wherein the first conductor and the second conductor differ in torsional compliance;
crimping the compression sleeve;
providing a force to pull out the first conductor, the second conductor, or the first conductor and the second conductor;
measuring the pull out resistance of the compression sleeve;
exceeding the failure point for pull out resistance of the compression sleeve;
identifying a failing conductor; wherein the failing conductor is determined based upon whether the first conductor or the second conductor results in at least one of over-flash, broken strands, and over-flash of the compression sleeve; and
producing a reengineered sleeve to increase the failure point for pull out resistance.

18. The process of claim 17, wherein the step of producing a reengineered sleeve to increase the failure point for pull out is a step selected from the group of steps consisting of:
modifying the diameter of the first bore;
modifying the diameter of the second bore;
modifying the profile of the compression sleeve;
modifying the die set profile; and
modifying the crimping tool;

19. The process of claim 18, further comprising preventing the first conductor and the second conductor from being pulled out with a force below the amount required under at least one of UL 486 and IEC 61238.

20. An electric connection for a wind turbine comprising:
a first conductor having a first torsional compliance; and
a second conductor having a second torsional compliance being different than the first torsional compliance of the first conductor.
